(19) United States
(12) Patent Application Publication
(10) Pub. No.: US 2005/0133570 A1
(43) Pub. Date: Jun. 23, 2005

(54) Method and apparatus for conductive ball bonding of components

(76) Inventors: Manuel Hernandez, San Jose, CA (US); Yen Fu, San Jose, CA (US); Ellis Cha, San Ramon, CA (US); Hong Tian, Tai Po (HK)

Correspondence Address: KENYON & KENYON, Suite 700, 1500 K Street, N.W., Washington, DC, 20005, US

(21) Appl. No.: 10/741,230

(22) Filed: Dec. 19, 2003

(51) Int. Cl. B23K 1/06; B23K 5/20; H01R 9/00

(52) U.S. Cl. 228/178; 228/110.1; 228/1.1; 228/4.1

(57) ABSTRACT

According to an embodiment of the present invention, an improved method and system are provided. In one embodiment, gold balls are provided and a holder using a vacuum suction force is used to pick up each gold ball. The ball is then placed next to the desired bonding pad(s) and vibrated to achieve partial melting of the ball and bonding pad(s).

### FIELD OF THE INVENTION

The present invention pertains to a method and apparatus for manufacturing components of a hard disk drive. More particularly, the present invention pertains to conductive ball bonding of components such as bonding pads on a head slider device and bonding pads on a suspension or the like.

### BACKGROUND OF THE INVENTION

Hard disk drives are common information storage devices essentially consisting of a series of rotatable disks that are accessed by magnetic reading and writing elements. These data transferring elements, commonly known as transducers, are typically carried by and embedded in a slider body that is held in a close relative position over discrete data tracks formed on a disk to permit a read or write operation to be carried out. In order to properly position the transducer with respect to the disk surface, an air bearing surface (ABS) formed on the slider body experiences a fluid air flow that provides sufficient lift force to “fly” the slider and transducer above the disk data tracks. The high-speed rotation of a magnetic disk generates a stream of airflow or wind along its surface in a direction substantially parallel to the tangential velocity of the disk. The airflow cooperates with the ABS of the slider body, which enables the slider to fly above the spinning disk. In effect, the suspended slider is physically separated from the disk surface through this self-actuating air bearing. The ABS of a slider is generally configured on the slider surface facing the rotating disk, and greatly influences its ability to fly over the disk under various conditions.

As shown in FIG. 1 an ABS design known for a common catamaran slider 5 may be formed with a pair of parallel rails 2 and 4 that extend along the outer edges of the slider surface facing the disk. Other ABS configurations including three or more additional rails, with various surface areas and geometries, have also been developed. The two rails 2 and 4 typically run along at least a portion of the slider body length from the leading edge 6 to the trailing edge 8. The leading edge 6 is defined as the edge of the slider that the rotating disk passes before running the length of the slider 5 towards a trailing edge 8. As shown, the leading edge 6 may be tapered despite the large undesirable tolerance typically associated with this machining process. The transducer or magnetic element 7 is typically mounted at some location along the trailing edge 8 of the slider as shown in FIG. 1. The rails 2 and 4 form an air bearing surface on which the slider flies, and provide the necessary lift upon contact with the air flow created by the spinning disk. As the disk rotates, the generated wind or air flow runs along underneath, and in between, the catamaran slider rails 2 and 4. As the air flow passes beneath the rails 2 and 4, the air pressure between the rails and the disk increases thereby providing positive pressurization and lift. Catamaran sliders generally create a sufficient amount of lift, or positive load force, to cause the slider to fly at appropriate heights above the rotating disk. In the absence of the rails 2 and 4, the large surface area of the slider body 5 would produce an excessively large air bearing surface area. In general, as the air bearing surface area increases, the amount of lift created is also increased. Without rails, the slider would therefore fly too far from the rotating disk thereby foregoing all of the described benefits of having a low flying height.

As illustrated in FIG. 2, a head gimbal assembly 40 often provides the slider with multiple degrees of freedom such as vertical spacing, or pitch angle and roll angle which describe the flying height of the slider. As shown in FIG. 2, a suspension 74 holds the HGA 40 over the moving disk 76 (having edge 70) and moving in the direction indicated by arrow 80. In operation of the disk drive shown in FIG. 2, an actuator 72 moves the HGA over various diameters of the disk 76 (e.g., inner diameter (ID), middle diameter (MD) and outer diameter (OD)) over arc 78.

The magnetic read/write head of the slider is electrically coupled to circuitry in the disk drive. Typically, bonding pads are provided on the slider that are to be electrically coupled to bonding pads on the suspension. In many cases, the bonding pads of the slider will be orthogonal to the bonding pads of the flexure. The prevalent method for providing this electrical connection is through conductive ball bonding. Gold and solder are examples of the materials used for the conductive balls. In one example of gold ball bonding, the gold is provided as a solid wire through a capillary, which holds the end of the wire in place. The gold is properly grounded. The slider is appropriately positioned on the suspension and placed on a support. A separate electrode is provided that is coupled to a voltage source via a switch. In this example, the orthogonal bonding pads of the slider/suspension are positioned below the tip of the gold wire. The electrode is brought close to the tip of the gold wire. Once the switch is closed, voltage as high as several thousand volts is applied to the electrode. This causes a spark to jump from the electrode to the gold wire and a portion of the gold wire melts. This process for creating a liquid gold ball is referred to in the art as electronic flame off (EFO).

The capillary holding the wire and molten gold ball and the support holding the suspension and slider are brought close to one another (e.g., the capillary is moved down towards the orthogonal bonding pads of the slider and the suspension). Force is applied to one of the components to push the gold ball and the bonding pads together. At the same time, vibration, such as ultrasonic vibration, is applied to one or both of the components. Friction between the gold ball and the bonding pads causes friction and the outer surfaces of the ball and pads heats up melting their outer layers, and resulting in an improved electrical connection between the pads via the gold ball. Finally the wire is pulled away from the slider/suspension and the ball breaks off from the wire.

One problem with this system is that the volume of the gold ball varies from placement to placement. If the volume is too small, then an electrical connection may not be made or may be too fragile and easily dislodged during operation of the slider/suspension (e.g., during a “head slap”). If the volume is too large, then the electrical connection could extend to other pads on the slider or suspension resulting in inoperability. This system also includes large voltages and sparks that can damage read/write circuitry of the slider (especially MR sensors).

In view of the above, there is a need for an improved method and apparatus for conductive ball bonding of electrical bonding pads.

### SUMMARY OF THE INVENTION

According to an embodiment of the present invention, an improved method and system are provided. In one embodiment, gold balls are provided and a holder using a vacuum suction force is used to pick up each gold ball. The ball is then placed next to the desired bonding pad(s) and vibrated to achieve partial melting of the ball and bonding pad(s). Doing so relieves the need for the EFO processes of generating a spark to create the gold ball at the end of a gold wire.

### BRIEF DESCRIPTION OF THE DRAWINGS

FIG. 1 is a perspective view of a flying slider with a read and write element assembly having a tapered conventional catamaran air bearing slider configuration.

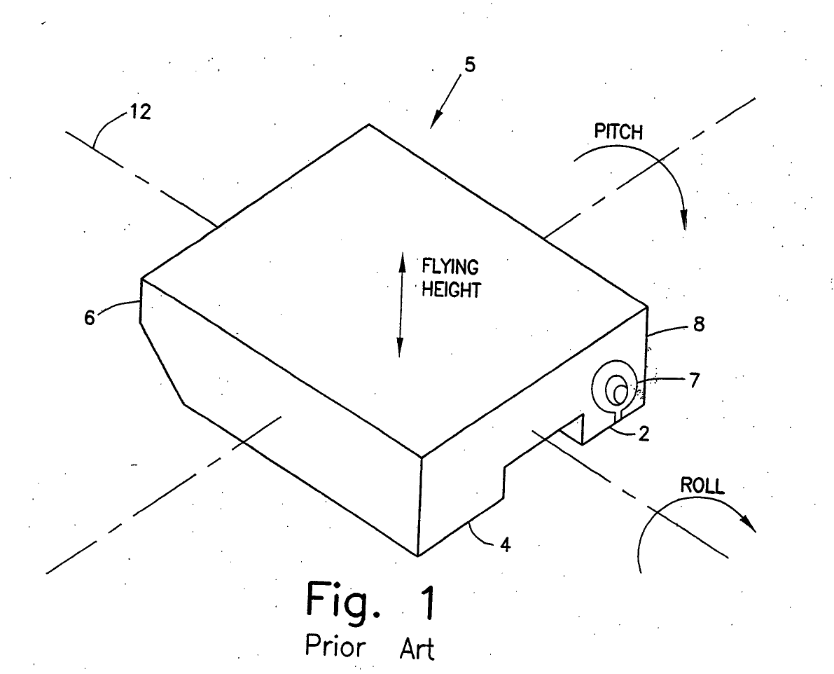

FIG. 2 is a plan view of a mounted air bearing slider over a moving magnetic storage medium.

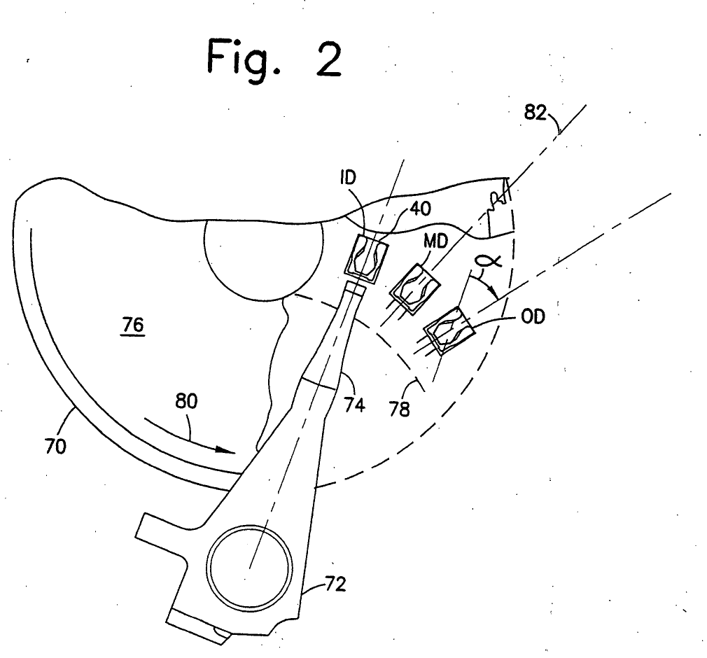

FIG. 3 is a diagram of a system implementing a first operation according to an embodiment of the present invention.

FIG. 4 is a diagram of the system of FIG. 3 implementing a second operation according to an embodiment of the present invention.

FIG. 5 is a diagram of the system of FIG. 3 implementing a third operation according to an embodiment of the present invention.

### DETAILED DESCRIPTION

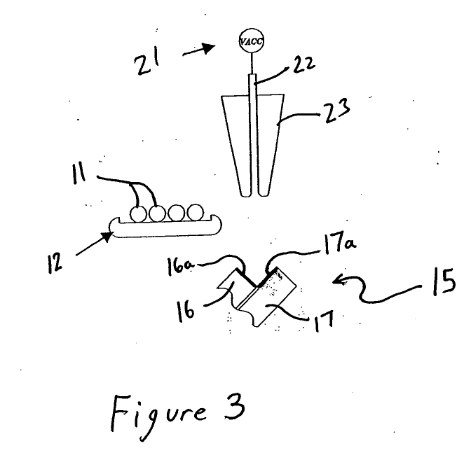

Referring to FIG. 3, a diagram of a first operation according to an embodiment of the present invention is shown. In this embodiment, a plurality of conductive balls are provided initially. As shown in FIG. 3, the conductive balls 11 are provided in a tray 12. In this example, the conductive balls are made of gold. Depending on the dimensions of the bonding pads, the conductive balls can have a variety of sizes. With a pad size of 140 micrometers, the conductive balls can have a diameter of 130 micrometers with a tolerance of 20 micrometers. With a pad of size of 90 micrometers, the conducive balls can have a diameter of 85 micrometers with a tolerance of 15. In this embodiment, the conductive balls are fabricated using an atomization process that produces balls have a wide range of diameters. Based on the sieving process, the balls can be sorted to meet the above qualifications. Conductive balls as described herein may be purchased from Technic, Inc. (Cranston, R.I.).

A workpiece 15 that requires an electrical connection to be made includes at least one bonding pad. In this example, workpiece 15 is a read/write slider 16 with bonding pad 16a and a suspension 17 with bonding pad 17a. A vacuum 21 is provided that provides a suction force for picking up one or more of the conductive balls. In this example, the vacuum is coupled to a cylinder 22, which in turn is coupled to or part of a holder 23. According to an embodiment of the present invention, holder 23 (with cylinder 22) is the same capillary that is used to hold conductive wire that is known in the art. Thus, the devices that are used to manipulate and/or hold the capillary and workpiece that are used in the EFO method described above may also be used to implement this embodiment of the present invention.

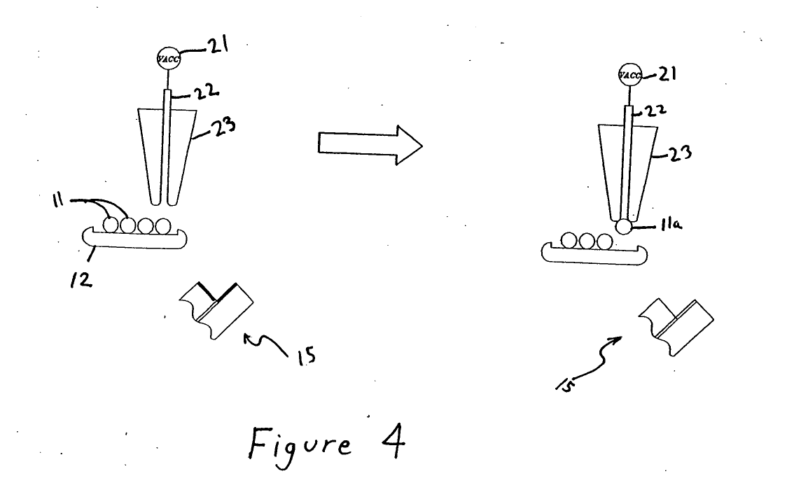

Referring to FIG. 4, a second operation of this embodiment is shown. In FIG. 4, the holder 23 is moved over the gold balls 11 and tray 12. With the vacuum 21 running, a suction force appears at the opening of holder 23. Because of the size of the opening, the suction force is of a sufficient magnitude that one of the balls 11a will become lodged in the holder's opening.

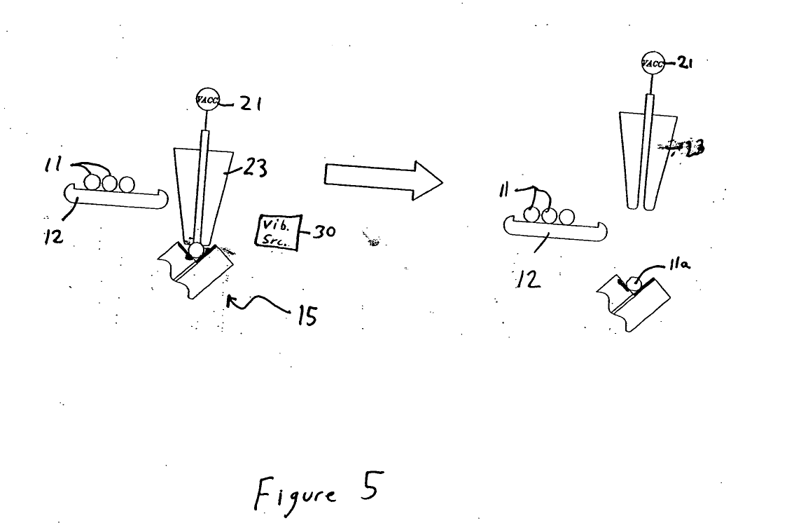

Referring to FIG. 5, a third operation of this embodiment is shown. In FIG. 5, the holder 23 is moved towards the workpiece 15 so that the ball 11a is in contact with at least one of the conductive pads. In this embodiment, a vibration source 30 provides ultrasonic vibration to the ball (e.g., through holder 23) causing the outer layer of the ball 11 to liquefy as well as the bonding pad(s) improving the electrical bond between them.

While the present invention has been described with reference to the aforementioned applications, this description of the preferred embodiments is not meant to be construed in a limiting sense. It shall be understood that all aspects of the present invention are not limited to the specific depictions, configurations or dimensions set forth herein which depend upon a variety of principles and variables. Various modifications in form and detail of the disclosed apparatus, as well as other variations of the present invention, will be apparent to a person skilled in the art upon reference to the present disclosure. It is therefore contemplated that the appended claims shall cover any such modifications or variations of the described embodiments as falling within the true spirit and scope of the present invention.

For example, though gold balls are described in the implementations of FIGS. 3-5, other conductive materials may be used, including solder, copper and silver (especially gold plated copper or silver balls, which are cheaper by volume than gold). Also, when stating above that one apparatus is moved towards another apparatus, one skilled in the art will appreciate either or both apparatus may be moved relative to each other to facilitate the method of creating an electrical connection as described above. Furthermore, though the embodiment of the present invention is directed to creating an electrical connection where there is an orthogonal relationship between the bonding pads (e.g., for a slider/suspension connection), the present invention can be expanded other types of relationships between the bonding pads including where the bonding pads are parallel to one another.

1. A method of forming a conductive ball bonding comprising:
providing a conductive ball;
picking up said conductive ball with a holder; and
placing said conductive ball, with said holder, in contact with a bonding pad.

2. The method of claim 1 further comprising:
providing vibration to said conductive ball to at least partially melt said conductive ball

3. The method of claim 2 wherein said conductive ball is made of gold.

4. A method of forming a conductive ball bonding comprising:
providing a plurality of conductive balls;
picking up a first one of said conductive balls with a holder;
providing at least one bonding pad to be coupled to said first conductive ball; and
positioning said conductive ball against said at least one bonding pad.

5. The method of claim 4 further comprising:
Providing vibration to said conductive ball to at least partially melt said conductive ball.

6. The method of claim 5, wherein said conductive balls are made of gold.

7. A method of forming a conductive ball bonding between a bonding pad on a slider and a bonding pad on a suspension, comprising:
Providing a plurality of conductive balls on a tray;
Picking up a first one of said conductive balls from said tray with a suction force via a holder;
Providing a slider coupled to a suspension, each of said slider and suspension including at least one bonding pad;
Placing said at least one conductive ball in contact with both of said bonding pads of said slider and said suspension.

8. The method of claim 7 further comprising;
Imparting vibration to said conductive ball to cause at least partial melting thereof.

9. The method of claim 7 further comprising:
Imparting vibration to said bonding pads of said slider and said suspension to cause at least partial melting of said conductive ball.

10. The method of claim 7 wherein said holder is a capillary and is coupled to a vacuum source.

11. The method of claim 10 wherein said conductive ball is made of gold.

12. The method of claim 10 wherein said conductive ball is made at least one of gold, silver, and copper.

13. A system for creating a conductive ball bond comprising:
A holder to pick up a conductive ball; and
A support holding a component including a bonding pad, such that said holder is to place said conductive ball in contact with said bonding pad.

14. The system of claim 13 further comprising:
a vibration source to impart vibration to said conductive ball.

15. The system of claim 13 wherein said holder is a capillary including an opening, said system further comprising:
a vacuum source coupled to said capillary to create a suction force at the opening of said capillary to pick up said conductive ball.

16. The system of claim 15 wherein said component is a slider having a first bonding pad in an orthogonal relationship to a second bonding pad of a suspension.

17. The system of claim 16 wherein said conductive ball is made of at least one of the following: gold, silver, and copper.
